(19) United States
(12) Patent Application Publication
(10) Pub. No.: US 2024/0143290 A1
(43) Pub. Date: May 2, 2024

(54) Concept for Orchestration of Microservices

(71) Applicant: Intel Corporation, Santa Clara, CA (US)

(72) Inventors: Tat Kin TAN, BAYAN LEPAS (MY); Kamarul Zaman ABDUL RASHID, Bayan Lepas (MY)

(21) Appl. No.: 17/934,581

(22) Filed: Sep. 23, 2022

(51) Int. Cl. G06F 8/34; G06F 8/10; G06F 8/51; G06F 8/60

(52) U.S. Cl. CPC G06F 8/34; G06F 8/10; G06F 8/51; G06F 8/60

(57) ABSTRACT

An apparatus is provided. The apparatus comprises interface circuitry, machine-readable instructions and processing circuitry to execute the machine-readable instructions. The machine-readable instruction may be stored on a storage device. The machine-readable instructions is to receive, from an interface apparatus, user data indicative of a hardware microservice requested by a user. Further, it is to receive, from a database, microservice data indicative of a plurality of hardware microservices. Further, it is to determine a hardware microservice based on the plurality of hardware microservices and the requested hardware microservice of the user.

### BACKGROUND

Application Developers are provided with abundance of choice of Integrated Development Environment (IDE). Each of the individual IDE has its own unique features and styles and every IDE is aimed to assist developers writing software codes more effectively. In recent times, IDE are becoming more developer and user friendly, focusing on User Experience (UX) and Developer Experience (DX) factors and principles.

The IDE typically offer simple code editing environment and providing native tools and features to help improve coding productivity plus preventing syntax and coding inefficiencies and facilitate ease of refactoring software codes with tooltips and other user-assist features with some offering templates according to user-interface (UI) patterns. IDE contain its own catalog or structure of libraries for its unique coding environment and mostly programming language dependent.

While the concept of modeling hardware microservices often existed in hardware engineering practice through simulation technologies and platforms, it is almost non-existent in application software development space. In this instance, application developers develop base code or method to enable a hardware microservice. The base code depends on or is tightly coupled to the programming language. A base code developed in a first IDE environment must be rewritten in another language if a new owner unfamiliar with the first IDE environment wishes to adopt it. There is no abstraction solution where they can instantaneously simulate, or rapidly configure different conceptual representation of software. Thus, there may be need to increase an accessibility/eligibility of hardware microservices.

### BRIEF DESCRIPTION OF THE FIGURES

Some examples of apparatuses and/or methods will be described in the following by way of example only, and with reference to the accompanying figures, in which

FIG. 1 shows an example of a block diagram of a trusted platform module service provisioning building block;

FIG. 2 shows a block diagram of an example of an apparatus;

FIG. 3 shows a block diagram of an example of an interface apparatus;

FIGS. 4a and 4b show an example of functional parts of the architecture of the apparatus and the interface apparatus;

FIG. 5 shows a block diagram of an example of a method;

FIG. 6 shows a timing diagram of the hardware microservice mapping and rendering flow;

FIG. 7 shows an example of a method for an apparatus;

FIG. 8 shows an example of a method for an interface apparatus; and

FIG. 9 shows a computing device.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

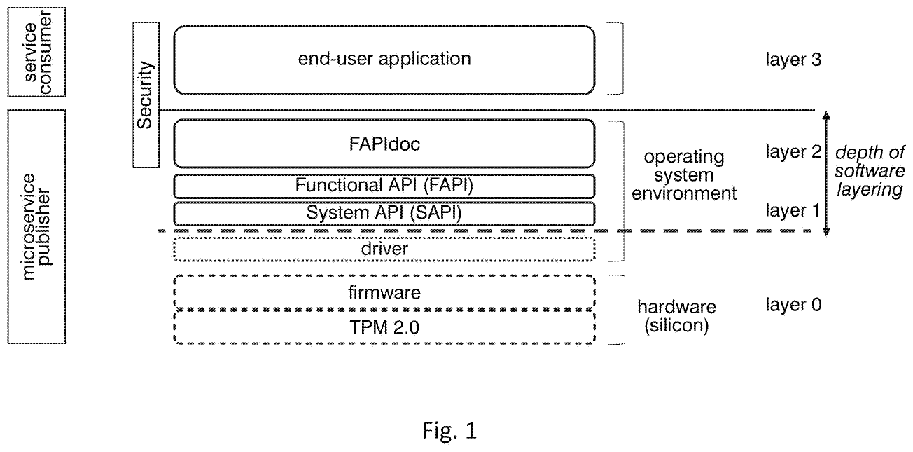

FIG. 1 shows an example of a block diagram of a trusted platform module (TPM) service provisioning building block.

A user, such as an application software developer, is expected to make the effort to enable and deploy hardware microservices from scratch, based on documentation, collaterals, and a support ecosystem that comes with a steep learning curve, or to engage third-party software integrators. Today, if a user wants to use a typical TPM hardware feature, he must download a TPM firmware either from the manufacturer or from the Trust Computing Group (TCG) and then manually create and bind such TPM firmware codes as part of a software library, either as System Application Program Interface (SAPI) or Functional API (FAPI) and include them in some form of hardware microservices. The user must refer to the user manual and design documentation (firmware and drivers) via services that can be provided to a development environment. Application codes can then use the exposed TPM interface.

As shown in FIG. 1, multiple software layers are involved in creating a software application that uses hardware microservices of a hardware intellectual property (e.g., TPM2.0). The process may comprise manual porting of hardware microservices across IDE consumption. If a user decides to use a different IDE, the hardware microservices cannot be ported over unchanged and the user must recreate or manually port the hardware microservices. Software developers will have to port these different layers of software designs, libraries or services based on different characteristics and operability of IDE. Therefore, a DX Intent must be created and operated differently on different IDE. This may decrease accessibility and/or eligibility of hardware microservices.

The apparatuses as described below focus on hardware microservices and the usability of hardware microservice, especially for different IDE.

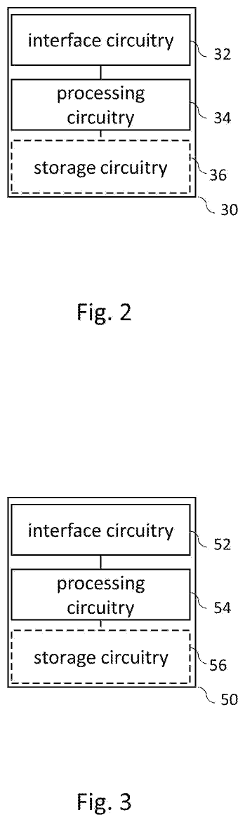

More details and aspects are mentioned in connection with the examples described below. The example shown in FIG. 1 may comprise one or more optional additional features corresponding to one or more aspects mentioned in connection with the proposed concept or one or more examples described below (e.g., FIG. 2-9).

FIG. 2 shows a block diagram of an example of an apparatus 30. The apparatus 30 comprises interface circuitry 32, machine-readable instructions and processing circuitry 34 to execute the machine-readable instructions. The machine-readable instruction may be stored on a storage device, e.g., the storage circuitry 36. The machine-readable instructions is to receive, from an interface apparatus, user data indicative of a hardware microservice requested by a user. For example, the user data may comprise data indicative of a hardware microservices execution design recipe. Further, it is to receive, from a database, microservice data indicative of a plurality of hardware microservices. Further, it is to determine a hardware microservice based on the plurality of hardware microservices and the requested hardware microservice of the user. By receiving data indicating a requested hardware microservice, information about a desired hardware microservice can be obtained. The desired hardware microservice can be matched with a plurality of hardware microservices to determine if the desired hardware microservice is available. By determining the hardware microservice the desired hardware microservice can be provided to the user. In this way, the user can access a desired hardware microservice in an improved way. For example, a need to use a programming language of an interface apparatus, e.g., a programming language of an IDE, can be omitted.

The apparatus 30 comprises circuitry that is configured to provide the functionality of the apparatus 30. For example, the apparatus 30 comprises interface circuitry 32, processing circuitry 34 and (optional) storage circuitry 36. For example, the processing circuitry 34 may be coupled with the interface circuitry 32 and with the storage circuitry 36. For example, the processing circuitry 34 may be configured to provide the functionality of the apparatus 30, in conjunction with the interface circuitry 32 (for exchanging information, e.g., with the interface apparatus) and the storage circuitry 36 (for storing information, such as machine-readable instructions). Likewise, the apparatus 30 may comprise means that is/are configured to provide the functionality of the apparatus 30. The components of apparatus 30 are defined as component means, which may correspond to, or implemented by, the respective structural components of the apparatus 30. For example, the apparatus 30 of FIG. 2 comprises means for processing 34, which may correspond to or be implemented by the processing circuitry 34, means for communicating 32, which may correspond to or be implemented by the interface circuitry 32, and (optional) means for storing information 36, which may correspond to or be implemented by the storage circuitry 36. In general, the functionality of the processing circuitry 34 or means for processing 34 may be implemented by the processing circuitry 34 or means for processing 34 executing machine-readable instructions. Accordingly, any feature ascribed to the processing circuitry 34 or means for processing 34 may be defined by one or more instructions of a plurality of machine-readable instructions. The apparatus 30 may comprise the machine-readable instructions, e.g., within the storage circuitry 36 or means for storing information 36.

In general terms, a user, such as an application software developer, experiences technical challenges when it comes to sharing and collaborating their low-code/no-code (LCNC) DX intent, design outputs, plus associated libraries and job-aids across different developer communities using different IDE. Each of the Low-code Development Platform (LCDP) available today's mandates their own proprietary designer platform tool environment or IDE. Using the apparatus 30 a design interchangeability and/or design experience agnostic to the programming language and the IDE and/or designer platform used to create the preceding hardware microservices execution design recipe, also referred to as draft, using a hardware microservice, can be provided.

In this way, an application developers can share their DX intent with each other. A DX intent can be a desired action of the user such as a request for exploring different hardware microservices, the usage of the hardware microservice in a draft (e.g., in a software application). Further, a need to re-write the same hardware microservices for different programming languages to port the hardware microservice to a different 4GL or 5GL programming language base can be omitted. By using the determined hardware microservice the DX intent design notation or interchange may be with respect to the hardware microservice independently from the native LCDP visual format. In this way, collaboration between different LCDP can be leveraged. Further, interoperability between IDE and designer platforms can be achieved.

This apparatus 30 can solve the technical challenge of identifying and managing DX intent and translate and/or map the DX intent into hardware microservices for IDE. In this way an IDE interoperability can be provided. The DX intent of the developer can be part of the user data, e.g., the user wants to us the requested hardware microservice. A managing of the DX intent can be provided by receiving managing data (indicative of the plurality of hardware microservice) and determining a hardware microservice based on the microservice data. In this way, the hardware microservice stored in the database can be accessed by the interface apparatus. Using the DX intent, which may be a part of the user data, the user can access the hardware microservices and can perform certain (supported) actions such as explore, model and/or deploy the hardware microservices. In this way, the user can generate in an eased way a software program based on the hardware microservices which can be spread between different IDE.

This may mean that a new capability to manage user intention can be provided. For example, the user may intend to use a hardware microservice with an IDE running on the interface apparatus. The intention of the user to use the hardware microservice can be a DX intent, such as exploration, modeling or deployment, on the hardware microservice. Using the apparatus 30 the microservices utilization from the IDE can be managed by determining the hardware microservice for the DX intent. The apparatus 30 may provide a harmonized and consistent hardware microservices DX intent facade. This can connect different IDE where software developers can exchange DX intents that are translated into software codes for hardware microservices without worrying about which IDE to use. In this way, a user using a first IDE can generate a draft comprising a first hardware microservice and can provide this draft to a second user using a second IDE. Thus, the user can share his draft with different IDE.

For example, the user data may be based on a programming language used for an IDE running on the interface apparatus. In contrast, the microservice data may be based on a programming language to look-up hardware microservices. In this way, the hardware microservice can be accessed by the user without a need to use a programming language for accessing the hardware microservice. For example, the format of the draft can be converted into a native format supported by another IDE. Because each IDE has its own native format to read, render and/or display the base code/design written by a developer by converting the draft into a native format this could be accessed by a plurality of IDE.

The apparatus 30, also referred to as a microservices mediation (or rendering) engine (MME), may assist user in controlling hardware microservices proliferation across different IDE. In this way, a unique access for different IDE to the plurality of hardware microservice can be provided.

The MME 30 may be a cloud-based to access hardware microservices. Further, the MME 30 can be used to as an orchestration engine for the hardware microservices. The MME 30 may be capable to provision hardware microservices according to a DX intent. Further, the MME may arrange associated (e.g., associated to the request) hardware microservice recipe for rendering actions in an IDE of the interface apparatus. By determining the hardware microservice a hardware microservice associated to the user data (e.g., the requested hardware microservice) can be determined and optionally transmitted to the interface apparatus. In this way, a user of the interface apparatus may receive access to the requested hardware microservice.

The MME 30 may allow hardware (HW) or software (SW) intellectual property (IP) owners to publish a hardware microservice catalog, such as to allow easy exploration, modelling and consumption, especially from different IDE. For example, the hardware microservice catalog may be stored in the database. Thus, the MME 30 can receive the microservice data indicative of the hardware microservice catalog from the database. In this way, an owner of HW IP such as a manufacturer of a processor or processing circuitry, can provide the HW IP capability as a hardware microservices to the interface apparatus. The MME 30 can be at least accepted as an industry standard or best practice. Thus, an application developer can use a desired variant of an IDE to access the plurality of hardware microservices via the MME 30.

The MME 30 can provide interoperability within different IDE, and/or may allow ease of design of hardware microservices. In this way, a common user-friendly design platform can be created that may stimulate creativity of a user (e.g., a software developer) and/or encourage them to browse, explore and/or model hardware microservices catalogs within their preferred IDE.

The MME 30 may provide a software modeling tool that provide, renders, publishes, and/or deploys hardware microservices constituents, and/or is capable of providing a software recipe (e.g., mapped data) for a software or system to support several functionalities of hardware microservices, e.g., Explore, Model, and Deploy modeling phases. For example, Explore, Model, and Deploy as described in the U.S. patent application Ser. No. 17/643,854 (which is hereby incorporated by reference in its entirety).

The user data may comprise information about an DX intent which may basically refer to the action of exploring, the action of modeling and the action of deploying different hardware microservices. For example, the user data may comprise information about requested hardware microservices a user of the interface apparatus wants to explore, e.g., to select a desired hardware microservice.

The database can be a cloud server, a backend, a persistent storage (e.g., RAM/ROM).

The MME 30 can provide a modelling pallet that offers a user a hardware microservices catalogue for selection. Further, the hardware microservice can be used for an application into a final implementation. In this way, a capability to orchestrate, distribute and/or render hardware microservices to a user, such as SW application developer, can be provided. For example, a SW application developer may request a certain hardware microservice by a UX/DX intent. The UX/DX intent may be transmitted from the interface apparatus to the MME 30 via the user data. The MME may determine a desired hardware microservice. Further, the MME may transmit mapped data indicative of the determined hardware microservice to the interface apparatus. Alternatively, when the MME 30 determines a hardware microservice, which does not fulfill the user UX/DX intent no transmission of microservice data may be performed.

The MME 30 can extent the DX intent, experience, usage conditions and/or cross share (interoperability) the interchange model of the design draft across multiple IDE. Further, a harmonized hardware microservices design can be offered by the MME 30. In this way, an IDE agnostic environment and experience can be created.

In an example, the processing circuitry may be further (configured) to transmit, to the interface apparatus, mapped data indicative of the determined hardware microservice. By transmitting mapped data the interface apparatus can be informed about the determined hardware microservice. In this way, the user of the interface apparatus can get access to a requested hardware microservice. Thus, a DX intent can be processed by the apparatus and a user experience can be increased.

The apparatus 30 may determine the hardware microservice based on a comparison between a requested hardware microservice and the plurality of hardware microservices. For example, if the user data is indicative for a specific hardware microservice part of the plurality of hardware microservices, this specific hardware microservice may be determined from the plurality of hardware microservices. Alternatively, when the specific hardware microservice is not part of the plurality of hardware microservice the apparatus 30 may determine a hardware microservice with a comparable feature or functionality.

Optionally or alternatively, the apparatus 30 may determine the hardware microservice based on a DX intent behavioral modeling engine. The apparatus 30 can make a decision based on the DX intents received from an ingress filter (e.g., a (first) tunnel). Further, the apparatus 30 may transmit the DX intents mapped to the corresponding microservices to an egress filter. The egress filter (e.g., a (second) tunnel) may generate the mapped data by emulating the determined hardware microservices for transmitting. For example, the determined hardware microservice may be emulated to a programming language which can be processed by the interface apparatus.

In an example, the user data may comprise an integrated development environment language of the interface apparatus and the microservice data may comprise a look-up language to lookup hardware microservices. For example, the integrated development environment language may be a programming language of an IDE installed on the interface apparatus. A user may use the IDE and wants to access a certain hardware microservice. Thus, the user may request the hardware microservice based on the programming language of the IDE. In this way, the user data may comprise the programming language of the IDE, which may be inappropriate to look-up the plurality of hardware microservices.

For example, the look-up language may be a programming language used to obtain the plurality of hardware microservice. For example, the look-up language can be used to explore the hardware microservice according to the DX intent. The look-up language may provide the capability to orchestrate, distribute and/or render microservices to a user as described above. In this way, be utilizing different programming languages an access for the user using an IDE can be provided independently of a programming language of the IDE.

In an example, the mapped data may comprise an (response) integrated development environment language of the interface apparatus and/or a universal language which could be interpreted by the interface apparatus. For example, the (response) IDE language may be a programming language of an IDE installed on the interface apparatus. The (response) IDE language can be identical to the IDE language part of the user data. In this way, the interface apparatus may receive data indicative of the hardware microservice in the same programming language as an IDE installed on the interface circuitry. Thus, the user can get access to the hardware microservice by use of a desired IDE. As described above the determined hardware microservice may be emulated by use of the egress filter to provide a programming language, which can be interpreted by the IDE of the interface apparatus.

Optionally or alternatively, the (response) IDE language may be a programming language different from the one part of the user data which could be interpreted by the interface apparatus. For example, the (response) IDE language can be at least accepted as an industry standard or best practice. In this way, the interface apparatus can use the mapped data independently of an IDE installed on the interface circuitry. Thus, a user can get eased access to the requested hardware microservice. For example, the mapped data may comprise a microservices catalogue and the DX intent.

In an example, the processing circuitry 34 may be further (configured) to establish a connection between the interface apparatus and the interface circuitry by a tunnel. By establishing a connection between the interface apparatus and the apparatus 30 the user can request and receive access to a desired hardware microservice. In this way, the user can benefit from the functionality of the apparatus 30, e.g., explore, model, deploy hardware microservices. The tunnel can be any suitable connection between the interface apparatus and the apparatus 30. For example, the tunnel can be a virtual tunnel, a link, a bridge, a message bus mechanism, to transmit the user data and optionally mapped data.

For example, using the tunnel a solution in today's LCDP or LCNC space can be provided that can offer hardware microservices development experience. The tunneling mechanism to connect the interface apparatus, e.g., an IDE installed on the interface apparatus, to the apparatus 30, e.g., a backend server providing a backend service, which can handle exploring, deploying and/or modeling of the plurality of hardware microservices, e.g., part of hardware catalog. In this way, a software services from the interface apparatus (e.g., an IDE installed on a client) to the apparatus (e.g., hardware microservices of a datacenter, e.g., comprising the database) can be provided.

In an example, the processing circuitry 34 may be further (configured) to establish a connection between the database and the interface circuitry 32 by a tunnel. The tunnel can be any suitable connection between the interface apparatus and the apparatus 30. For example, the tunnel can be a virtual tunnel, a link, a bridge, a message bus mechanism, to transmit the user data and optionally mapped data.

In an example, the processing circuitry 34 may be further (configured) to render the plurality of hardware microservices to the requested hardware microservice. By rendering the plurality of hardware microservices to the requested hardware microservice the determination of the hardware microservice can be improved. In this way, the user experience can be improved. For example, when a specific requested hardware microservice is not part of the plurality of hardware microservices the apparatus 30 may determine an adequate surrogate hardware microservice.

In an example, the processing circuitry 34 may be further (configured) to obtain a statistic of requested hardware microservice and transmit offer data indicative of an offered hardware microservice to the interface circuitry. By obtaining a statistic the user of the interface circuitry can receive information about appropriate available hardware microservices. In this way, the user experience can be improved by, for example, suggesting hardware microservices that might be of interest to the user.

For example, obtaining the statistic may comprise collect and gather intelligence usage statistics of a DX intent. The DX intent could be translated into a concept of offering hardware microservices. In this way, a hardware microscope that might be of interest to the user can be determined by the apparatus 30 and can be transmitted via the mapped data to the interface apparatus. Thus, the user can receive information about hardware microservice without directly requesting. In this way, the user can be informed about interesting and/or new hardware microservices.

In an example, the apparatus 30 may be part of a cloud computer or may be a cloud computer.

In an example, the interface apparatus may be part of an end client and the apparatus is part of a server. In an example, the processing circuitry 34 may be further (configured) to receive, from multiple databases, microservice data indicative of a plurality of hardware microservices of the multiple databases. In this way, the apparatus can offer hardware microservices from multiple servers.

As shown in FIG. 2 the respective interface circuitry 32 is coupled to the respective processing circuitry 34 at the apparatus 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the interface circuitry 32, so that any data transfer that occurs over the interface circuitry 32 and/or any interaction in which the interface circuitry 32 may be involved may be controlled by the processing circuitry 34.

In an example the apparatus 30 may comprise a memory and at least one processing circuitry 34 operably coupled to the memory and configured to perform the below mentioned method.

In examples the interface circuitry 32 may correspond to any means for obtaining, receiving, transmitting or providing analog or digital signals or information, e.g. any connector, contact, pin, register, input port, output port, conductor, lane, etc. which allows providing or obtaining a signal or information. The interface circuitry 32 may be wireless or wireline and it may be configured to communicate, e.g., transmit or receive signals, information with further internal or external components.

The apparatus 30 may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system.

More details and aspects are mentioned in connection with the examples described above and/or below. The example shown in FIG. 2 may comprise one or more optional additional features corresponding to one or more aspects mentioned in connection with the proposed concept or one or more examples described above (e.g., FIG. 1) and/or below (e.g., FIG. 3-9).

FIG. 3 shows a block diagram of an example of an interface apparatus 50. The interface apparatus 50 comprises interface circuitry 52, machine-readable instructions and processing circuitry 54 to execute the machine-readable instructions. The machine-readable instruction may be stored on a storage device, e.g., the storage circuitry 56. The machine-readable instructions is to transmit, to the interface apparatus as described above, e.g., with reference to FIG. 2, user data indicative of a hardware microservice requested by a user. Further, it is to receive, from the interface apparatus, mapped data indicative of a determined hardware microservice based on the user data. By receiving the mapped data a user of the interface apparatus can get access to a required hardware microservice. In this way, the user experience can be improved. For example, the user can use a desired IDE to access a requested hardware microservice. The interface apparatus 50 may be a counterpart of the apparatus 30 as described with reference to FIG. 1.

The interface apparatus 50 comprises circuitry that is configured to provide the functionality of the interface apparatus 50. For example, the interface apparatus 50 comprises interface circuitry 52, processing circuitry 54 and (optional) storage circuitry 56. For example, the processing circuitry 54 may be coupled with the interface circuitry 52 and with the storage circuitry 56. For example, the processing circuitry 54 may be configured to provide the functionality of the interface apparatus 50, in conjunction with the interface circuitry 52 (for exchanging information, e.g., with the interface apparatus) and the storage circuitry 56 (for storing information, such as machine-readable instructions). Likewise, the interface apparatus 50 may comprise means that is/are configured to provide the functionality of the interface apparatus 50. The components of interface apparatus 50 are defined as component means, which may correspond to, or implemented by, the respective structural components of the interface apparatus 50. For example, the interface apparatus 50 of FIG. 3 comprises means for processing 54, which may correspond to or be implemented by the processing circuitry 54, means for communicating 52, which may correspond to or be implemented by the interface circuitry 52, and (optional) means for storing information 56, which may correspond to or be implemented by the storage circuitry 56. In general, the functionality of the processing circuitry 54 or means for processing 54 may be implemented by the processing circuitry 54 or means for processing 54 executing machine-readable instructions. Accordingly, any feature ascribed to the processing circuitry 54 or means for processing 54 may be defined by one or more instructions of a plurality of machine-readable instructions. The interface apparatus 50 may comprise the machine-readable instructions, e.g., within the storage circuitry 56 or means for storing information 56.

The interface apparatus 50 may allow a user, such as an application developer, using any IDE of choice, to consume hardware microservices. The user can consume the hardware microservices in a flexible design manner that conforms to DX and UX principles. The DX intent of the user can be fulfilled by the interface apparatus 50. For example, a DX intent such as exploring a catalog of hardware microservices (Explore), visualize the representation of the microservices to assist developers to design or model their implementations (Model), support the process of converting the model or design into full feature development in a software programming language of choice (Deploy), can be intercepted.

Further, receiving the mapped data may enable and enrich DX and UX within an IDE, such that the user can get an increased freedom to exchange DX intents. Further, the user can tap into hardware features which are traditionally stayed hidden or are not accessible. This can allow the user to be more creative in the design of their software. For example, the user can get the ability to design software applications with hardware microservices in their own IDE.

The interface apparatus 50 can provide a software development experience built upon hardware microservices by enabling the user to access hardware microservices. In this way, a user, e.g., a user of the LCDP market, can utilize hardware microservices, for example. The interface apparatus 50 may provide a penetration to a plurality of IDE for a user such as a software developer.

Each of the LCDP available today's mandates their own proprietary designer platform tool environment or IDE. The interface apparatus 50 may offer a design interchangeability, and/or design experience agnostic to the programming language, the IDE and the designer platform. User experience technical challenges when it comes to sharing and collaborating their LCNC DX intent, design outputs, plus associated libraries and job-aids across different developer communities using different IDE. Using the interface apparatus 50 and the mapped data an exchange about hardware microservice can be eased. In this way, user using different IDE can access the same hardware microservices and/or share their work, e.g., a draft, using the hardware microservices. For example, the user can instantaneously simulate and/or rapidly configure different conceptual representation of software based on a hardware microservices abstraction solution. This hardware microservices abstraction solution can be spread between different IDE.

This can be achieved by implementing an interface such as a software plugin into the IDE. For example, the machine-readable instruction may be to integrate a software plugin for an IDE, e. g., a software plugin to detect and identify characteristics of the IDE, and/or to offer DX authentication of the IDE. In this way, a compatibility of the IDE with the apparatus as described above can be checked. The interface apparatus 50, e.g., the software plugin, may be communicatively coupled to the apparatus via a tunnel as described above. For example, the software may be a plugin interface to offer interoperability between IDE upon rendering or provisioning the DX services/intents, to increase and uplift overall application DX. Note, that the software plugin may be no software wizard.

By utilizing the interface apparatus 50 an IDE can be enabled to accept, process and/or render a hardware microservices recipe (e.g., the mapped data may comprise a hardware microservice recipe) and/or an input via a software plugin. In this way, the formulation of actions or user/developer experience patterns to enhance DX intent can be provided.

By using a tunnel and optionally a mediating mechanism to bridge between IDE with the apparatus, e.g., the backend software engine that can handle hardware microservices exploration, modeling and/or deployment, the user can access requested hardware microservices.

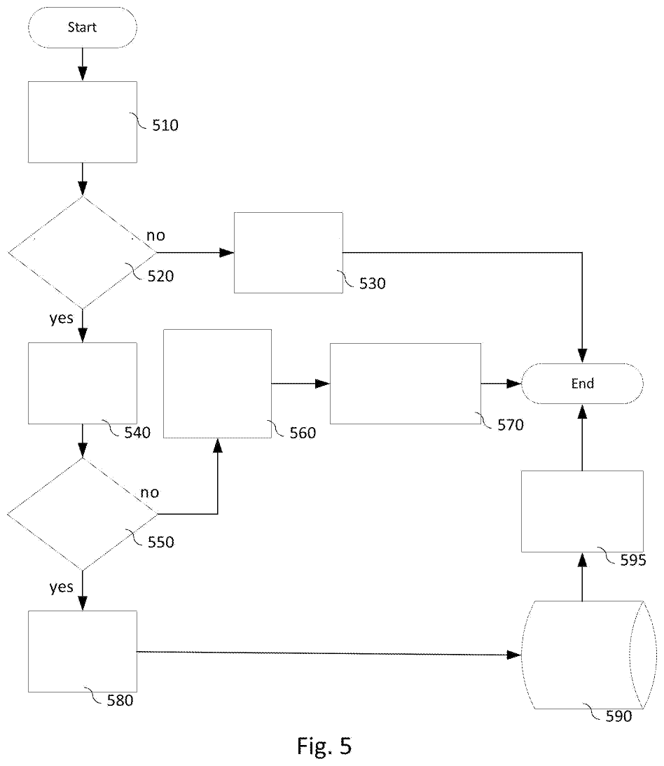

In an example, the processing circuitry 54 may be further (configured) to check whether the user data is supported by the apparatus (see also FIG. 5). As described above the user data may comprise information about a DX intent of a user, e.g., a requested hardware microservice. By checking whether the user data is supported the user can receive a feedback on a desired action. For example, an action such as Explore, Model or Deploy may be supported by the apparatus 50.

In an example, when the user data comprises an unsupported DX intent the interface apparatus 50 may be to document, tag and/or record the unsupported intent, e.g., to transmit data indicative of the unsupported intent to the apparatus such as the MME for future (backend) analysis. In this way, a process for an unsupported DX intent can be captured and/or documented, e.g., in the database, a cloud, a ROM, a RAM.

In an example, the processing circuitry 54 may be further (configured) to detect, categorize and/or manage the requested hardware microservice of the user. A supported DX intent can be registered in an approved list as safe entry. Thus, the user data may only comprise a DX intent which is registered in the approved list. In this way, the user data may only comprise a DX intent relevant for the apparatus, e.g., an action supported by the apparatus.

In an example, the processing circuitry 54 may be further (configured) to establish a user interface to receive the user data by generating a software hook into a development environment. The user interface may be the software plugin as described above. A DX intent detection interface with software may hook to categorize DX intent and/or facilitate interactions with a hardware microservices catalogue on the apparatus.

As shown in FIG. 3 the respective interface circuitry 52 is coupled to the respective processing circuitry 54 at the apparatus 50. In examples the processing circuitry 54 may be implemented using one or more processing units, one or more processing devices, any means for processing, such as a processor, a computer or a programmable hardware component being operable with accordingly adapted software. Similar, the described functions of the processing circuitry 54 may as well be implemented in software, which is then executed on one or more programmable hardware components. Such hardware components may comprise a general-purpose processor, a Digital Signal Processor (DSP), a micro-controller, etc. The processing circuitry 54 is capable of controlling the interface circuitry 52, so that any data transfer that occurs over the interface circuitry 52 and/or any interaction in which the interface circuitry 52 may be involved may be controlled by the processing circuitry 54.

In an example the apparatus 50 may comprise a memory and at least one processing circuitry 54 operably coupled to the memory and configured to perform the below mentioned method.

In examples the interface circuitry 52 may correspond to any means for obtaining, receiving, transmitting or providing analog or digital signals or information, e.g. any connector, contact, pin, register, input port, output port, conductor, lane, etc. which allows providing or obtaining a signal or information. The interface circuitry 52 may be wireless or wireline and it may be configured to communicate, e.g., transmit or receive signals, information with further internal or external components.

The functions of the interface apparatus 50 and the apparatus 30 in interaction are described in more detail below.

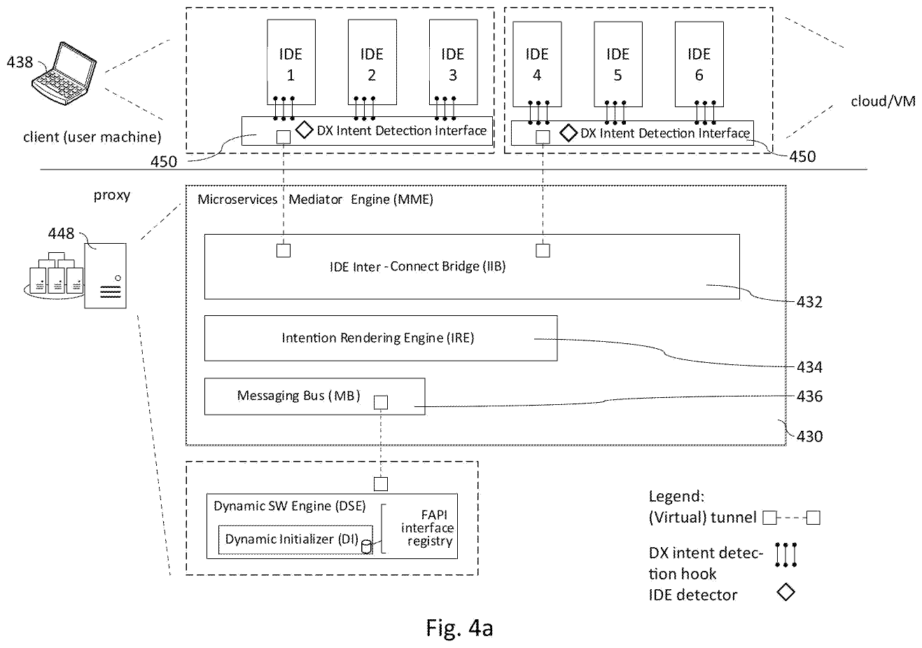

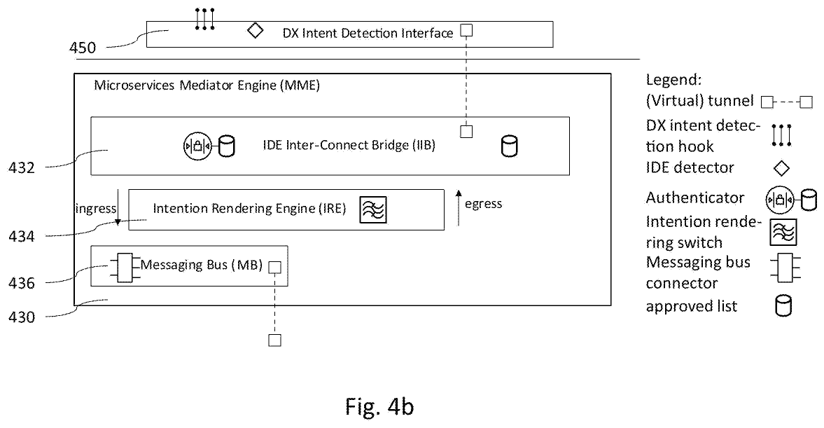

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIG. 4-9).

FIGS. 4a and 4b show an example of functional parts of the architecture of the apparatus and the interface apparatus. FIG. 4a shows an overview of an entire system comprising the apparatus as described with reference to FIG. 2 and the interface apparatus as described with reference to FIG. 3.

In systems as described with reference to FIG. 1 there is no possibility in LCDP or LCNC space to access hardware microservices from multiple different IDE to provide a development experience. The apparatus and the interface apparatus offer a unique system to leverage the usage of hardware microservices. For this, a plugin to an IDE of choice may be integrated by use of the interface apparatus. Further, a virtual tunneling mechanism to connect the IDE to a backend service (provided by the apparatus) that can handle browsing and modeling of hardware catalogs may be provided. In this way, a software service from user device 438 (e.g., comprising an IDE) to a datacenter (hardware intellectual property) via the apparatus 450 can be provided. For example, the apparatus 450 and the datacenter may be part of a proxy 448, e.g., a cloud computer. The interface apparatus may be part of the user device 438.

For example, the core architecture may consist of a main interface named as MME 430 and a DX intent detection interface (DXIDI). Each may have one operation mode. The operation mode of the DXIDI 450 may be to detect, categorize and manage the DX intents of the user. The operation mode of the MME 430 may be to process the DX intent. For this, the DX intent may be part of the user data as described above and may be transmitted from the DXIDI 450 to the MME.

The DXIDI 450 may be integrated in the IDE and can be implemented as a DX Intent Detection Hook. The IDE can usually be located near the user, e.g., the software developers, who usually have the IDE of their choice installed locally on a user device 438. The user device 438 can be a desktop computer, a laptop computer, a tablet computer, be on-premise or remote in a cloud as a web-based online IDE. The MME 430 may be integrated in a proxy layer of the apparatus such as a cloud computer, a server, a backend.

The MME 430 may be further connected with an interface from a Dynamic Serializer to retrieve a catalog of hardware microservices from a federated registry (database) in the cloud.

FIG. 4b shows a detail view of the apparatus and the interface apparatus as shown in FIG. 4a comprising the architectural building blocks of the MME 430 and the DXIDI 450. There may be four unique functional blocks within this MME 430/DXIDI 450 architecture and each of the block may be responsible to offer a different flow of service.

The MME 430 can be a backend engine (e.g. HTTP) for operating the DXIDI 450, which can be installed as a plugin in the IDE of choice of a user device. The DXIDI 450 can detect the IDE platform such as whether the user is using IDE1, IDE2, IDE3, IDE 4 or IDE 5. The DXIDI 450 may have a software hook (e.g., a DX Intent Detection Hook) created to detect and/or categorize different software DX intents. This software hook can be implemented via an IDE Detector, for example. The DX intent can be an intent for exploration of a catalog of hardware microservices, an intent to model the implementation of hardware microservices and/or an intent to deploy or provision of hardware microservices into different programming languages. These supported DX intents can be registered in an approved-list as safe entries.

THE MME 430 and the DXIDI 450 may be communicatively connected via a virtual tunnel. The main function of this virtual tunnel can be to facilitate data exchange between the DXIDI 450 and the IDE Inter-connect Bridge (IIB) 432 of the MME 430. So there can be two endpoints for this virtual tunnel. One may lead to the DXIDI 450 integrated in the IDE and the other to the IIB 432 interface in a cloud.

The IIB 432 may be a gatekeeper to the outflow of hardware microservices to the DXIDI 450. Further, the IIB 432 may be designed to provide authentication of the virtual tunnel. IIB 432 can work with DXIDI 450 to establish the virtual tunnel after successful authentication (e.g. user login). The implementation may allow user login or authentication to identify a DXIDI 450 of an IDE to be a one-time process. The IIB 432 may contain a local persistent database that can be synchronized with the hardware microservice accessibility security database.

The Intention Rendering Engine (IRE) 434 may be a software state machine to orchestrate hardware microservice content. This software state machine may be a DX intent behavioral modeling engine. It may decide based on the DX intents received from an ingress filter, and render the DX intent mapped to the relevant microservices to an egress filter. It may propagate and emulate the required hardware microservice. Within the IRE 434 there may be a subprocess capable to determine and classify the DX intent, such as whether the DX intent belongs to a certain DX gesture. A DX gesture can be a gesture of exploration of microservices, thus facilitating the retrieval of a catalog of hardware microservices, for example. A gesture can be a gesture of modeling microservices and hence facilitating the right sequence of microservices, for example.

When an unsupported DX intent is detected, the DX Intent Detection Hooks may be used to transmit (user) data to the IIB 432 indicative to add the foreign (new) DX intent as an anomaly in the same approved list. Then the IIB 432 may publish the anomaly to the cloud, e.g., the database.

Once the hardware microservices are presented to the IDE in a formulated unified format by the IRE, the user can freely share the hardware microservices between different application developers with different IDE.

The Messaging Bus (MB) 436 may be a data path highway to exclusively connect to a Dynamic Serializer to handle message exchange offering a connection to a registry. This design may be important as it may allow hardware microservices data connectivity and served as the data highway to retrieve relevant microservices.

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIGS. 1-3) and/or below (e.g., FIG. 5-9).

FIG. 5 shows a block diagram of an example of a method 500. The method 500 shows the software logics and the core mechanism behind the MME/DXIDI creation.

The method comprises in 510 detecting and identifying and IDE connectivity. Once the user has triggered or initiated a DX intent from an IDE, an IDE authentication process is initiated in 520. When IDE authentication process failed due to the reason such as unsupported IDE, a message should be notifying the users to try using a universal IDE version which support the desired hardware microservices. Once the IDE is identified and authenticated, a virtual tunnel is established for the transmission of DX intent in 540. The IRE analyzes the incoming DX intent, filter and/or classify the DX intent. Further, the IRE checks in 550 whether the DX intent is supported by the MME. If the DX intent is not supported by the MME the foreign (new) DX intent may be marked as an anomaly in an approved list. Then the IIB may publish the anomaly to the cloud, e.g., the database. If the DX intent is supported the IRE maps relevant hardware microservice to the DX intent in 580. In 590 the IRE retrieves the DX intent from backend database from the Messaging Bus. The formulated microservices are then rendered back to the DXIDI in 595.

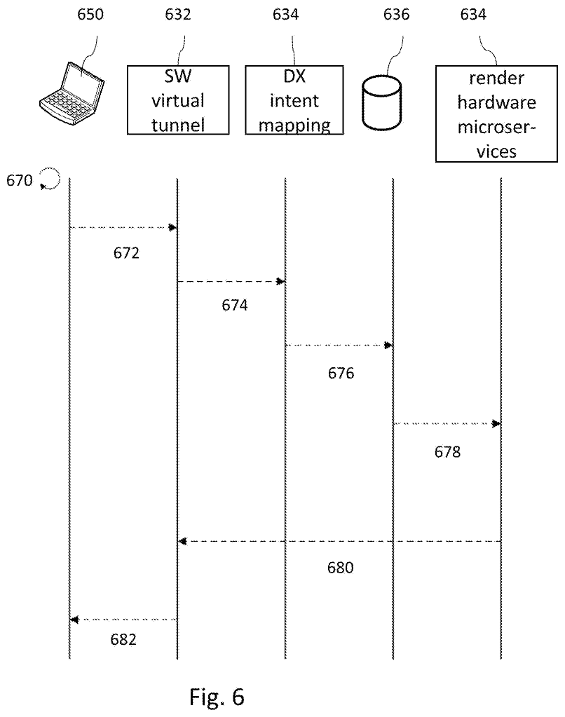

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIGS. 1-4) and/or below (e.g., FIG. 6-9).

FIG. 6 shows a timing diagram of the hardware microservice mapping and rendering flow. The timing diagram comprises several steps performed by a DXIDI 650, an IIB 632, an IRE 634 and a MB 636.

The DX design intent of an IDE should trigger the MME, which accesses the mapping of the DX intent to hardware microservice and retrieves and renders the correct hardware microservice for the IDE.

In 670 an IDE authentication is performed by the DXIDI 650, which may be part of a user device. In 672 the DX intent is associated with an ingress filter, e.g., a SW virtual tunnel. The IIB 632 may triggers a DX intent processing in 674. In this way, a DX intent can be performed.

In 676 the IRE 634 retrieves mapped microservices from the MB 636. Further, the IRE 634 formulates the hardware microservice and renders it to the IDE in 678. In 680 the hardware microservice is associated with an egress filter, e.g., a SW virtual tunnel. In 682 the hardware microservice provisioning is transmitted to the IDE.

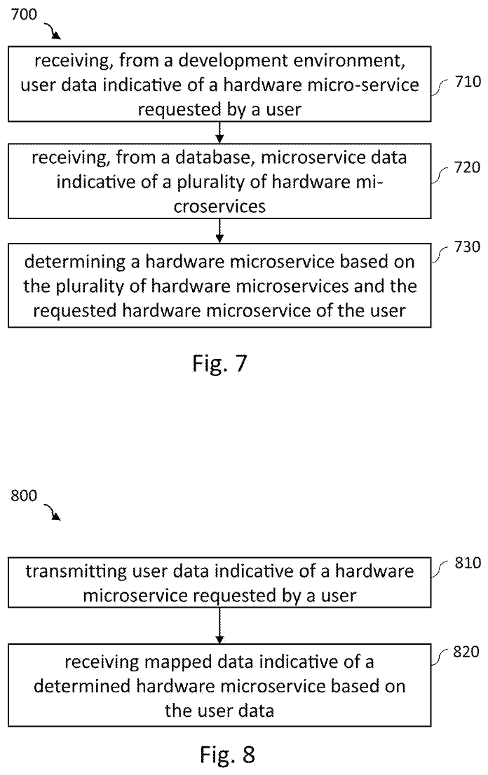

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIGS. 1-5) and/or below (e.g., FIG. 7-9).

FIG. 7 shows an example of a method 700 for an apparatus. The method 700 comprises receiving 710, from a development environment, user data indicative of a hardware microservice requested by a user. The method 700 further comprises receiving 720, from a database, microservice data indicative of a plurality of hardware microservices and determining 730 a hardware microservice based on the plurality of hardware microservices and the requested hardware microservice of the user. The method may be performed an apparatus as described in above, e.g., with reference to FIG. 2.

In an example, the method 700 may further comprise establishing at least one tunnel between a mediation engine and a development environment or a mediation engine and a database.

In an example, the method 700 may further comprise provision hardware microservices of the plurality of hardware microservice according to the user data and arranging an associated hardware microservice recipe for rendering actions in a development environment.

In an example, the method 700 may further comprise providing a catalog of determined hardware microservices based on the plurality of hardware microservices and the requested hardware microservice of the user.

In an example, the method 700 may further comprise generating a universal format comprising the determined hardware service.

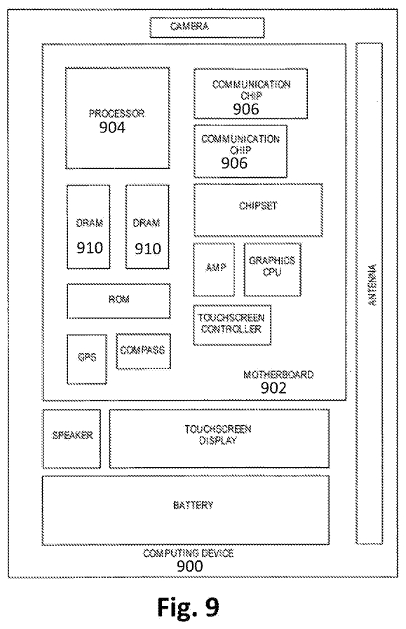

More details and aspects are mentioned in connection with the examples described above and/or below. The example shown in FIG. 7 may comprise one or more optional additional features corresponding to one or more aspects mentioned in connection with the proposed concept or one or more examples described above (e.g., FIGS. 1-6) and/or below (e.g., FIG. 8-9).

FIG. 8 shows an example of a method 800 for an interface apparatus. The method 800 may comprise transmitting 810 user data indicative of a hardware microservice requested by a user and receiving 820 mapped data indicative of a determined hardware microservice based on the user data. The method 800 may be performed by an interface apparatus as described with reference to FIG. 3.

More details and aspects are mentioned in connection with the examples described above and/or below. The example shown in FIG. 8 may comprise one or more optional additional features corresponding to one or more aspects mentioned in connection with the proposed concept or one or more examples described above (e.g., FIGS. 1-7) and/or below (e.g., FIG. 9).

FIG. 9 shows a computing device 900. The computing device 900 houses a board 902. The board 902 may include a number of components, including but not limited to a processor 904 and at least one communication chip 906. An apparatus as described above (e.g., with reference to FIG. 2) or an interface apparatus as described above (e.g., with reference to FIG. 3) may be part of the processor 904 as shown in FIG. 9.

The processor 904 is physically and electrically coupled to the board 902. In some examples the at least one communication chip 906 is also physically and electrically coupled to the board 902. In further examples, the communication chip 906 is part of the processor 904.

Depending on its applications, computing device 900 may include other components that may or may not be physically and electrically coupled to the board 902. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing device 900 includes an integrated circuit die packaged within the processor 904. In some examples, the integrated circuit die of the processor includes one or more devices that are assembled in an ePLB or eWLB based POP package that that includes a mold layer directly contacting a substrate, in accordance with examples. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another example, the integrated circuit die of the communication chip includes one or more devices that are assembled in an ePLB or eWLB based POP package that that includes a mold layer directly contacting a substrate, in accordance with examples.

More details and aspects are mentioned in connection with the examples described above. The example shown in FIG. 9 may comprise one or more optional additional features corresponding to one or more aspects mentioned in connection with the proposed concept or one or more examples described above (e.g., FIG. 1-8).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means.

Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and sub combinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached FIGS. may not show the various ways in which the disclosed methods can be used in conjunction with other methods.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

In the following, some examples of the proposed concept are presented:

An example (e.g., example 1) relates to an apparatus, the apparatus comprising interface circuitry, machine-readable instructions and processing circuitry to execute the machine-readable instructions to receive, from an interface apparatus, user data indicative of a hardware microservice requested by a user, receive, from a database, microservice data indicative of a plurality of hardware microservices, and processing circuitry to determine a hardware microservice based on the plurality of hardware microservices and the requested hardware microservice of the user.

An example (e.g., example 1a) relates to a processing module, comprising means for processing and means for storing information, wherein the processing module is configured to receive, from an interface apparatus, user data indicative of a hardware microservice requested by a user, receive, from a database, microservice data indicative of a plurality of hardware microservices, and processing circuitry to determine a hardware microservice based on the plurality of hardware microservices and the requested hardware microservice of the user.

Another example (e.g., example 2) relates to a previous example (e.g., the example 1) wherein the processing circuitry is further to transmit, to the interface apparatus, mapped data indicative of the determined hardware microservice.

Another example (e.g., example 3) relates to a previous example (e.g., one of the examples 1 or 2) or to any other example, wherein the user data comprises an integrated development environment language of an integrated development environment of the interface apparatus and the microservice data comprises a look-up language to look-up hardware microservices.

Another example (e.g., example 4) relates to a previous example (e.g., one of the examples 1 to 3) or to any other example, wherein the mapped data comprises an integrated development environment language of an integrated development environment of the interface apparatus or a universal language which could be interpreted by the interface apparatus.

Another example (e.g., example 5) relates to a previous example (e.g., one of the examples 1 to 4) or to any other example, wherein the processing circuitry is further to establish a connection between the interface apparatus and the interface circuitry by a tunnel.

Another example (e.g., example 6) relates to a previous example (e.g., one of the examples 1 to 5) or to any other example, wherein the processing circuitry is further to establish a connection between the database and the interface circuitry by a tunnel.

Another example (e.g., example 7) relates to a previous example (e.g., one of the examples 1 to 6) or to any other example, wherein the processing circuitry is further to render the plurality of hardware microservices to the requested hardware microservice.

Another example (e.g., example 8) relates to a previous example (e.g., one of the examples 1 to 7) or to any other example, wherein the processing circuitry 34 is further to obtain a statistic of requested hardware microservice, and transmit offer data indicative of an offered hardware microservice to the interface circuitry. the apparatus is part of a cloud computer.

An example (e.g., example 9) relates to an apparatus, the apparatus comprising interface circuitry, machine-readable instructions and processing circuitry to execute the machine-readable instructions to transmit, to the apparatus according to any of the preceding examples, user data indicative of a hardware microservice requested by a user, and receive, from the apparatus, mapped data indicative of a determined hardware microservice based on the user data.

An example (e.g., example 9a) relates to an apparatus, comprising means for processing and means for storing information, wherein the apparatus is configured to transmit, to the apparatus according to any of the preceding examples, user data indicative of a hardware microservice requested by a user, and receive, from the apparatus, mapped data indicative of a determined hardware microservice based on the user data.

Another example (e.g., example 10) relates to a previous example (e.g., example 9) or to any other example, wherein the processing circuitry is further to check whether the user data is supported by the apparatus.

Another example (e.g., example 11) relates to a previous example (e.g., one of the examples 9 or 10) or to any other example, wherein the processing circuitry is further to categorize the requested hardware microservice of the user.

Another example (e.g., example 12) relates to a previous example (e.g., one of the examples 9 to 11) or to any other example, wherein the processing circuitry is further to establish a user interface to receive the user data by generating a software hook into a development environment.

Another example (e.g., example 13) relates to a previous example (e.g., one of the examples 9 to 12) or to any other example, wherein when the user data comprises an unsupported DX intent the interface apparatus is further to perform at least one of document, tag or record the unsupported intent.

An example (e.g., example 14) relates to a method, comprising receiving, from a development environment, user data indicative of a hardware microservice requested by a user, receiving, from a database, microservice data indicative of a plurality of hardware microservices, and determining a hardware microservice based on the plurality of hardware microservices and the requested hardware microservice of the user.

Another example (e.g., example 15) relates to a previous example (e.g., example 14) or to any other example, further comprising establishing at least one tunnel between a mediation engine and a development environment or a mediation engine and a database.

Another example (e.g., example 16) relates to a previous example (e.g., one of the examples 14 or 15) or to any other example, further comprising provision hardware microservices of the plurality of hardware microservice according to the user data, and arranging an associated hardware microservice recipe for rendering actions in a development environment.

Another example (e.g., example 17) relates to a previous example (e.g., one of the examples 14 to 16) or to any other example, further comprising providing a catalog of determined hardware microservices based on the plurality of hardware microservices and the requested hardware microservice of the user.

Another example (e.g., example 18) relates to a previous example (e.g., one of the examples 14 to 17) or to any other example, further comprising generating a universal format comprising the determined hardware service.

An example (e.g., example 19) relates to a method, comprising transmitting user data indicative of a hardware microservice requested by a user, and receiving mapped data indicative of a determined hardware microservice based on the user data.

An example (e.g., example 20) relates to a non-transitory, computer-readable medium comprising a program code that, when the program code is executed on a computer, a processor, or a programmable hardware component, performs the method according to example 14.

An example (e.g., example 21) relates to a non-transitory, computer-readable medium comprising a program code that, when the program code is executed on a computer, a processor, or a programmable hardware component, performs the method according to example 19.

An example (e.g., example 22) relates to a computer program having a program code for performing the method of the above examples (e.g., one of the examples 14 to 19), when the computer program is executed on a computer, a processor, or a programmable hardware component.

An example (e.g., example 23) relates to a machine-readable storage including machine readable instructions, when executed, to implement a method or realize an apparatus as described in any of the above examples (e.g., one of the examples 1 to 19).

Another example (e.g., example 24) relates to a previous example (e.g., one of the examples 1 to 8) or to any other example, wherein the interface apparatus is part of an end client and the apparatus is part of a server.

Another example (e.g., example 25) relates to a previous example (e.g., one of the examples 1 to 9) or to any other example, wherein the processing circuitry is further to receive, from multiple databases, microservice data indicative of a plurality of hardware microservices of the multiple databases.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus, the apparatus comprising interface circuitry, machine-readable instructions and processing circuitry to execute the machine-readable instructions to:
receive, from an interface apparatus, user data indicative of a hardware microservice requested by a user;
receive, from a database, microservice data indicative of a plurality of hardware microservices; and
determine a hardware microservice based on the plurality of hardware microservices and the requested hardware microservice of the user.

2. The apparatus according to claim 1, wherein
the processing circuitry is further to transmit, to the interface apparatus, mapped data indicative of the determined hardware microservice.

3. The apparatus according to claim 1, wherein
the user data comprises an integrated development environment language of the interface apparatus and the microservice data comprises a look-up language to look-up hardware microservices.

4. The apparatus according to claim 1, wherein
the mapped data comprises an integrated development environment language of the interface apparatus or a universal language which could be interpreted by the interface apparatus.

5. The apparatus according to claim 1, wherein
the processing circuitry is further to establish a connection between the interface apparatus and the interface circuitry by a tunnel.

6. The apparatus according to claim 1, wherein
the processing circuitry is further to establish a connection between the database and the interface circuitry by a tunnel.

7. The apparatus according to claim 1, wherein
the processing circuitry is further to render the plurality of hardware microservices to the requested hardware microservice.

8. The apparatus according to claim 1, wherein
the processing circuitry is further to:
obtain a statistic of requested hardware microservice; and
transmit offer data indicative of an offered hardware microservice to the interface circuitry.

9. The apparatus according to claim 1, wherein
interface apparatus is part of an end client and the apparatus is part of a server.

10. The apparatus according to claim 1, wherein
the processing circuitry is further to
receive, from multiple databases, microservice data indicative of a plurality of hardware microservices of the multiple databases.

11. An apparatus, the apparatus comprising interface circuitry, machine-readable instructions and processing circuitry to execute the machine-readable instructions to:
transmit, to the apparatus according to claim 1, user data indicative of a hardware microservice requested by a user; and
receive, from the apparatus, mapped data indicative of a determined hardware microservice based on the user data.

12. The interface apparatus according to claim 11, wherein
the processing circuitry is further to check whether the user data is supported by the apparatus.

13. The interface apparatus according to claim 11, wherein
the processing circuitry is further to categorize the requested hardware microservice of the user.

14. The interface apparatus according to claim 11, wherein
the processing circuitry is further to establish a user interface to receive the user data by generating a software hook into a development environment.

15. The interface apparatus according to claim 12, wherein
when the user data comprises an unsupported DX intent the interface apparatus is further to perform at least one of document, tag or record the unsupported intent.

16. A method, comprising:
receiving, from a development environment, user data indicative of a hardware microservice requested by a user;
receiving, from a database, microservice data indicative of a plurality of hardware microservices; and
determining a hardware microservice based on the plurality of hardware microservices and the requested hardware microservice of the user.

17. The method according to claim 16, further comprising
establishing at least one tunnel between a mediation engine and a development environment or a mediation engine and a database.

18. The method according to claim 16, further comprising:
provision hardware microservices of the plurality of hardware microservice according to the user data; and
arranging an associated hardware microservice recipe for rendering actions in a development environment.

19. The method according to claim 16, further comprising
providing a catalog of determined hardware microservices based on the plurality of hardware microservices and the requested hardware microservice of the user.

20. The method according to claim 16, further comprising
generating a universal format comprising the determined hardware service.

21. A method, comprising:
transmitting user data indicative of a hardware microservice requested by a user; and
receiving mapped data indicative of a determined hardware microservice based on the user data.

22. A non-transitory, computer-readable medium comprising a program code that, when the program code is executed on a computer, a processor, or a programmable hardware component, performs the method according to claim 16.

23. A non-transitory, computer-readable medium comprising a program code that, when the program code is executed on a computer, a processor, or a programmable hardware component, performs the method according to claim 21.
